(19) United States
(12) Patent Application Publication
(10) Pub. No.: US 2004/0158458 A1
(43) Pub. Date: Aug. 12, 2004

(54) Narrowband speech signal transmission system with perceptual low-frequency enhancement

(76) Inventors: Robert Johannes Sluijter, Eindhoven (NL); Erik Larsen, Eindhoven (NL); Andreas Johannes Gerrits, Eindhoven (NL); Ronaldus Maria Aarts, Eindhoven (NL)

Correspondence Address: Corporate Patent Counsel, Philips Electronics North America Corporation, P O Box 3001, Briarcliff Manor, NY, 10510, US

(21) Appl. No.: 10/480,665

(22) PCT Filed: Jun. 20, 2002
(86) PCT No.: PCT/IB02/02367

(30) Foreign Application Priority Data
Jun. 28, 2001 (EP) 01202503.7

(51) Int. Cl. G10L 19/00

(52) U.S. Cl. 704/201

(57) ABSTRACT

Described is a transmission system (20) comprising a transmitter (22) for transmitting a narrowband speech signal, e.g. bandwidth limited between 300 and 3400 Hz, to a receiver (24) via a transmission channel (26). The transmission system (20) is characterized in that the transmitter (22) or the receiver (24) comprise amplifying means (28,30,32,34,36,38) for enhancing a listener's perception of low-frequency speech signal components by amplifying a frequency band of the narrowband speech signal. The frequency band may contain frequencies in the range of 300-450 Hz. The amplifying means (28,30,32,34,36,38) may comprise a band pass filter (28,34) for deriving the frequency band from the narrowband speech signal and an amplifier (30,36) for amplifying the frequency band. The amplification of the frequency band gives a reinforced perception of frequency components below the narrowband speech signal (e.g. 50-300 Hz), compensating for the lack of the physical presence of these components.

The invention relates to a transmission system comprising a transmitter for transmitting a narrowband speech signal to a receiver via a transmission channel.

The invention further relates to a transmitter for transmitting a narrowband speech signal to a receiver via a transmission channel, to a receiver for receiving, via a transmission channel, a narrowband speech signal from a transmitter, to a method of transmitting a narrowband speech signal via a transmission channel and to a method of receiving, via a transmission channel, a narrowband speech signal.

A transmission system according to the preamble is known from the paper “Bandwidth extension of narrowband speech for low bit-rate wideband coding” by Jean-Marc Valin and Roch Lefebvre in the proceedings of the 2000 IEEE Workshop on speech coding “Meeting the challenges of the new millennium”, pp. 130-132.

Such transmission systems may for example be used for transmission of speech signals via a transmission medium such as a radio channel, a coaxial cable or an optical fibre. Such transmission systems can also be used for recording of speech signals on a recording medium such as a magnetic tape or disc. Possible applications are automatic answering machines, dictating machines and (mobile) telephones.

Narrowband speech, which is used in the existing telephone networks, has a bandwidth of 3100 Hz (300-3400 Hz). Speech sounds much more natural and intelligible if the bandwidth is increased to around 7 kHz (50-7000 Hz). Speech with this bandwidth is called wideband speech and has an additional low band (50-300 Hz) and high band (3400-7000 Hz).

From the narrowband speech signal, it is possible to retrieve the high band and low band by extrapolation. A number of such bandwidth extension methods are known, see for instance the above mentioned paper. Such methods can be used in the existing telephone networks without changing the network. At the receiving side (e.g. a mobile phone or an automatic answering machine) the narrowband speech can be extended to wideband speech. This extended wideband speech has an improved quality compared to the narrowband speech in terms of bandwidth. However, bandwidth extension also introduces artifacts due to the extrapolation. These problems can largely be avoided by replacing narrowband speech in the existing telephone networks by wideband speech. Several speech coding systems with bit rates ranging from 12 to 24 kbit/s can be used in such networks. A major obstacle for the introduction of wideband services are the costs involved in upgrading the existing networks. Therefore, the use of bandwidth extension methods can be a good intermediate step towards wideband speech services.

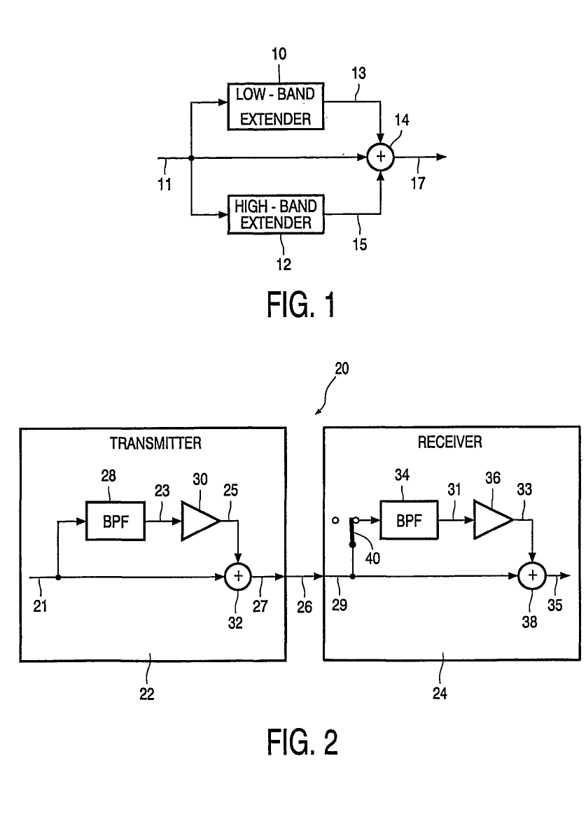

FIG. 1 shows a block diagram of a typical prior-art bandwidth extension system such as disclosed in the above mentioned paper. A high band speech signal 15 (e.g. having a frequency range of 3400-7000 Hz) and a low band speech signal 13 (e.g. having a frequency range of 50-300 Hz) are retrieved from a narrowband speech signal 11 (e.g. having a frequency range of 300-3400 Hz) by means of a high band extender 12 and a low band extender 10. Next, the low band speech signal 13, the high band speech signal 15 and the narrowband speech signal 11 are added by an adder 14 to obtain a wideband speech signal 17 (e.g. having a frequency range of 50-7000 Hz).

In the low band extender of the known transmission system a low band speech signal is derived from a narrow band speech signal by means of a controlled sinusoidal oscillator which generates the first two harmonics of the low band speech signal. Pitch analysis is used to determine the frequency of the oscillator. Furthermore, the phase of the generated harmonics is adjusted so that it remains coherent across frames. The amplitudes of the generated harmonics are scaled to the right amplitude. The scaling factor is estimated using a multi-layer perceptron network.

The generation of the low band speech signal from the narrowband speech signal in the known transmission has a number of drawbacks: it is relatively complex and it introduces noticeable artifacts.

It is an object of the invention to provide a transmission system as described in the opening paragraph which offers a more natural and intelligible sound quality as compared to a plain narrowband speech transmission system and which does not suffer from the above mentioned drawbacks of the known transmission system. This object is achieved in the transmission system according to the invention, which transmission system is characterized in that the transmitter or the receiver comprise amplifying means for enhancing a listener's perception of low-frequency speech signal components by amplifying a frequency band of the narrowband speech signal. The invention is based upon the recognition that an essential difference between speech and general audio signals (like e.g. music) is that speech is produced by one sound source only. With speech, an amplification of a frequency band of the narrowband speech signal will amplify the harmonics of the fundamental frequency, whereas in music there may be other frequencies components present in this frequency band (besides the harmonics of one fundamental frequency). The amplification of the frequency band gives a reinforced perception of frequency components below the narrowband speech signal, compensating for the lack of the physical presence of these components. The fact that a low pitch can be perceived when only higher harmonics are present is known per se as the missing fundamental effect.

An embodiment of the transmission system according to the invention is characterized in that a low cut-off frequency of the narrowband speech signal and a low cutoff frequency of the frequency band are substantially equal to each other. Experiments and listening tests have shown that the best results are achieved when the frequency band is located near the lower edge of the narrowband speech signal.

Another embodiment of the transmission system according to the invention is characterized in that the low cut-off frequency of the narrowband speech signal is 300 Hz and that the frequency band is bounded between substantially 300 Hz and substantially 450 Hz. The frequency range of approximately 300-450 Hz has been found to give good results in case of a narrowband speech signal that is lower bounded by 300 Hz, such as in telephone networks.

The above object and features of the present invention will be more apparent from the following description of the preferred embodiments with reference to the drawings, wherein:

FIG. 1 shows a block diagram of a prior art transmission system,

FIG. 2 shows a block diagram of an embodiment of the transmission system according to the invention.

FIG. 1 shows a block diagram of a typical prior-art bandwidth extension system such as disclosed in paper “Bandwidth extension of narrowband speech for low bit-rate wideband coding” by Jean-Marc Valin and Roch Lefebvre in the proceedings of the 2000 IEEE Workshop on speech coding “Meeting the challenges of the new millennium”, pp. 130-132. A high band speech signal 15 (e.g. having a frequency range of 3400-7000 Hz) and a low band speech signal 13 (e.g. having a frequency range of 50-300 Hz) are retrieved from a narrowband speech signal 11 (e.g. having a frequency range of 300-3400 Hz) by means of a high band extender 12 and a low band extender 10. Next, the low band speech signal 13, the high band speech signal 15 and the narrowband speech signal 11 are added by an adder 14 to obtain a wideband speech signal 17 (e.g. having a frequency range of 50-7000 Hz).

FIG. 2 shows a block diagram of an embodiment of the transmission system 20 according to the invention. The transmission system 20 comprises a transmitter 22 for transmitting a narrowband speech signal (300-3400 Hz) to a receiver 24 via a transmission channel 26. In order to enhance a listener's perception of low-frequency speech signal components in the transmitter 22 an input narrowband speech signal 21 is filtered by a band pass filter 28 and the resulting frequency band signal 23 is amplified by an amplifier 30. The amplified frequency band signal 25 is thereafter added to the input narrow band speech signal 21 by means of an adder 32. The resulting narrowband speech signal 27 is supplied to the transmission channel 26 for transmission to the receiver 24. In the transmitter 22 the amplifying means are formed by the band pass filter 28, the amplifier 30 and the adder 32.

Also, in order to enhance the listener's perception of low-frequency speech signal components in the receiver 24 the received narrowband speech signal 29 is filtered by a band pass filter 34 and the resulting frequency band signal 31 is amplified by an amplifier 36. The amplified frequency band signal 33 is thereafter added to the received narrow band speech signal 29 by means of an adder 38. The resulting narrowband speech signal 35 is supplied to other parts of the receiver, such as a loudspeaker (not shown). In the receiver 24 the amplifying means are formed by the band pass filter 34, the amplifier 36 and the adder 38.

The band pass filters 28 and 34 preferably have a low cut-off frequency of 300 Hz and a high cut-off frequency of 450 Hz. Instead of a flat response between 300 and 450 Hz, a filter characteristic which gradually decreases from 300 Hz may also be used in the band pass filters 28 and 34. The amplifiers 30 and 36 amplify the band-pass filtered signals 23 and 31 by a gain which has a typical value of 15 dB (which might be lowered in case of distortion at the reproduction end). An amplitude-dependent gain could be used as well, where low-amplitude signals give high gains, and high-amplitude signals give lower gains in the amplifiers 30 and 36. A dynamic range compressor may also be used for this function.

The receiver 24 also incorporates a switch 40 which, when opened, prevents the perceptual low-band enhancement. This switch 40 may be operated by three means:

User controlled; by a user switching the system on or off.

Signaling. If the transmitter has already performed the perceptual low-band enhancement, the receiver should not do the same processing again. In this case the transmitter may send an extra bit at the beginning of the communication, indicating the perceptual low-band enhancement in the signal.

Automatic detection. If the energy in the 300-450 Hz frequency band is already significantly higher than the energy in a higher band (typically 500-800 Hz), an extra low band enhancement will not be necessary. Also, this situation may indicate that the perceptual low band enhancement was already performed at the transmitter. Determination of the position of the switch 40 should be done once during communication, when a reliable decision can be made.

The perceptual low band enhancement scheme according to the invention may be combined in a receiver with a high band extender to obtain a perceptual wideband signal having a physical bandwidth of 300-7000 Hz.

Since this method generates no frequencies below 300 Hz, it can be applied on small loudspeaker which are typically used in mobile/cordless telephones and answering machines, which may not reproduce (all) frequencies below 300 Hz. Furthermore, no annoying artifacts are perceived in the perceptually enhanced low band speech. This is also the case when it is applied on speech with background noise and non-speech signals like music.

Although in FIG. 2 the transmitter 22 comprises the amplifying means 28,30,32 and the receiver 24 comprises the amplifying means 28,30,32,34,36,38 in general only the transmitter 22 or the receiver 24 will be equipped with such amplifying means. The amplifying means 28,30,32,34,36,38 (including the switch 40) may be implemented by means of digital or analog hardware or by means of software which is executed by a digital signal processor or by a general purpose microprocessor.

The scope of the invention is not limited to the embodiments explicitly disclosed. The invention is embodied in each new characteristic and each combination of characteristics. Any reference signs do not limit the scope of the claims. The word “comprising” does not exclude the presence of other elements or steps than those listed in a claim. Use of the word “a” or “an” preceding an element does not exclude the presence of a plurality of such elements.

1. A transmission system (20) comprising a transmitter (22) for transmitting a narrowband speech signal to a receiver (24) via a transmission channel (26), characterized in that the transmitter (22) or the receiver (24) comprise amplifying means (28,30,32,34,36,38) for enhancing a listener's perception of low-frequency speech signal components by amplifying a frequency band of the narrowband speech signal.

2. The transmission system (20) according to claim 1, characterized in that a low cut-off frequency of the narrowband speech signal and a low cut-off frequency of the frequency band are substantially equal to each other.

3. The transmission system (20) according to claim 1 or 2, characterized in that the low cut-off frequency of the narrowband speech signal is 300 Hz and that the frequency band is bounded between substantially 300 Hz and substantially 450 Hz.

4. The transmission system (20) according to any one of claims 1 to 3, characterized in that the amplifying means (28,30,32,34,36,38) comprise a band pass filter (28,34) for deriving the frequency band from the narrowband speech signal and an amplifier (30,36) for amplifying the frequency band.

5. A transmitter (22) for transmitting a narrowband speech signal to a receiver (24) via a transmission channel (26), characterized in that the transmitter (22) comprises amplifying means (28,30,32) for enhancing a listener's perception of low-frequency speech signal components by amplifying a frequency band of the narrowband speech signal.

6. The transmitter (22) according to claim 5, characterized in that a low cut-off frequency of the narrowband speech signal and a low cut-off frequency of the frequency band are substantially equal to each other.

7. The transmitter (22) according to claim 5 or 6, characterized in that the low cut-off frequency of the narrowband speech signal is 300 Hz and that the frequency band is bounded between substantially 300 Hz and substantially 450 Hz.

8. The transmitter (22) according to any one of claims 5 to 7, characterized in that the amplifying means (28,30,32) comprise a band pass filter (28) for deriving the frequency band from the narrowband speech signal and an amplifier (30) for amplifying the frequency band.

9. A receiver (24) for receiving, via a transmission channel (26), a narrowband speech signal from a transmitter (22), characterized in that the receiver (24) comprises amplifying means (34,36,38) for enhancing a listener's perception of low-frequency speech signal components by amplifying a frequency band of the narrowband speech signal.

10. The receiver (24) according to claim 9, characterized in that a low cut-off frequency of the narrowband speech signal and a low cut-off frequency of the frequency band are substantially equal to each other.

11. The receiver (24) according to claim 9 or 10, characterized in that the low cutoff frequency of the narrowband speech signal is 300 Hz and that the frequency band is bounded between substantially 300 Hz and substantially 450 Hz.

12. The receiver (24) according to any one of claims 9 to 11, characterized in that the amplifying means (34,36,38) comprise a band pass filter (34) for deriving the frequency band from the narrowband speech signal and an amplifier (36) for amplifying the frequency band.

13. A method of transmitting a narrowband speech signal via a transmission channel (16), characterized in that the method comprises enhancing a listener's perception of low-frequency speech signal components by amplifying a frequency band of the narrowband speech signal.

14. A method of receiving, via a transmission channel (16), a narrowband speech signal, characterized in that the method comprises enhancing a listener's perception of low-frequency speech signal components by amplifying a frequency band of the narrowband speech signal.
